(19) United States
(12) Patent Application Publication
(10) Pub. No.: US 2019/0366545 A1
(43) Pub. Date: Dec. 5, 2019

(54) Reconfigurable robotic system

(71) Applicant: RightHand Robotics, Inc., Somerville, MA (US)

(72) Inventors: Wilson Mefford, Cambridge, MA (US); Nicholas Payton, Somerville, MA (US); Andrew Campanella, Somerville, MA (US); Lael Odhner, Medford, MA (US)

(21) Appl. No.: 16/405,771

(22) Filed: May 7, 2019

Related U.S. Application Data
(60) Provisional application No. 62/677,621, filed on May 29, 2018.

(51) Int. Cl. B25J 9/16

(52) U.S. Cl. CPC B25J 9/1669; B25J 9/1661

(57) ABSTRACT

Methods and systems for operating a reconfigurable robotic system. The reconfigurable robotic system includes a robotic device that can transition between a stowaway state and a state in which the robotic device is in a work space to perform a task. The robotic device may be prevented from performing the task until the robotic device is properly positioned in the work space.

### CROSS-REFERENCE TO RELATED APPLICATIONS

The present application claims the benefit of and priority to co-pending U.S. provisional application no. 62/677,621, filed on May 29, 2018, the entire disclosure of which is incorporated by reference as if set forth in its entirety herein.

### TECHNICAL FIELD

Embodiments described herein generally relate to systems and methods involving robotic devices and, more particularly but not exclusively, to reconfigurable robotic systems and methods.

### BACKGROUND

Logistic operations such as those in warehouse environments often include robotic picking devices to gather items from a first location (e.g., a container) and place the items at a second location (e.g., on a conveyor belt) or vice versa. These robotic solutions are typically tailored to a very narrow class of pick items (e.g., boxes of similar size, shape, weight, etc.).

Because of these limitations, material flows inside the operational environment typically route items with similar characteristics to picking stations that are permanently configured for robotic operation. For example, an entire area in an environment may be configured with one or more robotic devices that are specifically designed to handle a particular type of item.

To ensure safety and stability, the workcells or stations typically use robotic arms that are either mounted to a base that requires a forklift or pallet jack to move, or are bolted to the floor using anchors or similar hardware. To convert these types of stations to enable other types of operations (e.g., operations or tasks involving a human operator or different types of robotic devices), facilities staff may be required to spend hours or days of labor to reconfigure the workstation. This may result in significant downtime and high associated costs.

A need exists, therefore, for robotic systems and methods that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a reconfigurable robotic system. The system includes a robotic device configured to be deployed to a first position that is in a work space to perform a task in the work space, and further configured to be moved to a second position that is outside of the work space while not performing the task, and at least one verification sensor to verify that the robotic device is properly positioned in the first position before the robotic device performs the task in the work space.

In some embodiments, the robotic device is operably connected to a support member configured to move the robotic device between the first and second positions. In some embodiments, the support member is a vertical support member mounted to a floor portion at a location such that the vertical support member can facilitate moving the robotic device between the first and second positions. In some embodiments, the system further includes a horizontal support member connecting the robotic device to the vertical support member, wherein the horizontal support member pivots about the vertical support member to facilitate moving the robotic device between the first and second positions.

In some embodiments, the robotic device is configured to be removably attached to a coupling to fix the robotic device in the first position. In some embodiments, the coupling is removably attached to a location in the work space or in proximity to the work space.

In some embodiments, the robotic device is configured to self-verify that it is properly positioned in the first position by detecting one or more fiducial markers in the work space or in proximity to the work space.

In some embodiments, the robotic device is configured to perform a pick-and-place task in the work space while in the first position.

In some embodiments, the system further includes a compensation mechanism to allow for variations in floor height between at least the first and second positions.

According to another aspect, embodiments relate to a method for operating a reconfigurable robotic system. The method includes deploying a robotic device to a first position that is in a work space to perform a task in the work space, enabling the robotic device to perform the task when the robotic device is properly positioned in the first position in the work space, and preventing the robotic device from performing the task when the robotic device is not properly positioned in the first position in the work space.

In some embodiments, the method further includes moving the robotic device about a support member from the first position to a second position. In some embodiments, the support member is a vertical support member mounted to a floor portion at a location such that the vertical support member can facilitate moving the robotic device between the first and second positions.

In some embodiments, the robotic device is operably connected to a horizontal support member, and the horizontal support member is configured to pivot about the vertical support member.

In some embodiments, the method further includes removably attaching the robotic device to a coupling to fix the robotic device in the first position. In some embodiments, the coupling is removably attached to a location in the work space or in proximity to the work space.

In some embodiments, properly positioning the robotic device in the first position comprises detecting, by the robotic device, one or more fiducial markers in the work space or in proximity to the work space.

In some embodiments, the method further includes receiving confirmation that the robotic device is properly positioned in the first position in the work space before enabling the robotic device to perform the task.

In some embodiments, the method further includes configuring the reconfigurable robotic system with a compensation mechanism to allow for variations in floor height when moving the robotic device to the second position.

According to yet another aspect, embodiments relate to a reconfigurable robotic system. The reconfigurable robotic system includes a robotic device configured to perform a task in a work space, a support member facilitating movement of the robotic device between a first position in which the robotic device can perform the task in the work space and a second position that is outside of the work space, and an attachment point configured to removably receive the robotic device to properly position the robotic device in the first position.

In some embodiments, the system further includes at least one verification sensor to verify that the robotic device is properly positioned in the first position before the robotic device performs the task in the work space, wherein the at least one verification sensor is configured with the attachment point.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIGS. 1A & B illustrate a reconfigurable robotic system in a stowaway configuration and in a deployed configuration, respectively, in accordance with one embodiment;

FIG. 2 illustrates a system architecture of a reconfigurable robotic system in accordance with one embodiment; and

FIG. 3 depicts a flowchart of a method for operating a reconfigurable robotic system in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

In existing warehouse and logistic operations, it is often desirable to convert a robotic picking station into a station that allows a human operator to perform a task therein (and vice versa). For certain workflows, material flows, required tasks, or the like, a single station may be used for multiple types of operations. These operations may include, but are not limited to, sorter induction, order packaging, tote replenishment, item extraction, item placement, etc.

These operations may be performed by a human operator or a robotic device. For various reasons, it may be desirable to have a human operator perform certain tasks as opposed to a robotic device or, in other scenarios, it may be desirable for a robotic device to perform certain tasks as opposed to a human operator.

As discussed above, however, reconfiguring robotic workstations is often a time consuming and labor intensive process. Additionally, the workstation is likely unavailable during the reconfiguration process, thereby contributing to downtime.

The embodiments described herein provide systems and methods for reconfiguring robotic workstations such as those in warehouses or otherwise those used in logistic operations. The systems and methods described herein can reconfigure a workstation to be in a robotic device state (in which a robotic device can perform a task) and a human operator state (in which a human operator can perform a task).

The systems and methods described herein can reconfigure the workstations without the need for vision system recalibration or manual confirmation that the robotic device is securely mounted in a desired position. For machine vision-guided robotic systems, for example, it is important to maintain the relative geometries of the robotic device, the imaging system(s), the pick location(s), the place location(s), etc. Failure to preserve these geometries or relationships therebetween may result in the robotic device and/or the imaging system needing to be recalibrated. Failure to preserve these geometries may also cause the robotic device to collide with surrounding objects or result in poor picking performance.

Additionally, motion of the robotic device (e.g., motion of a robotic arm or end effector) may create large impulses. It may therefore be necessary to obtain positive confirmation that the robotic device is properly secured not only in its operating position in the workstation but also in a stowaway position.

The features of the embodiments herein enable workstations to be reconfigured between the robotic device state and the human operator state without the need for recalibration of any vision systems and without requiring manual confirmation that the robotic device is properly positioned. This enables the robotic system to transition between the two states with minimal downtime and without comprising picking accuracy or safety.

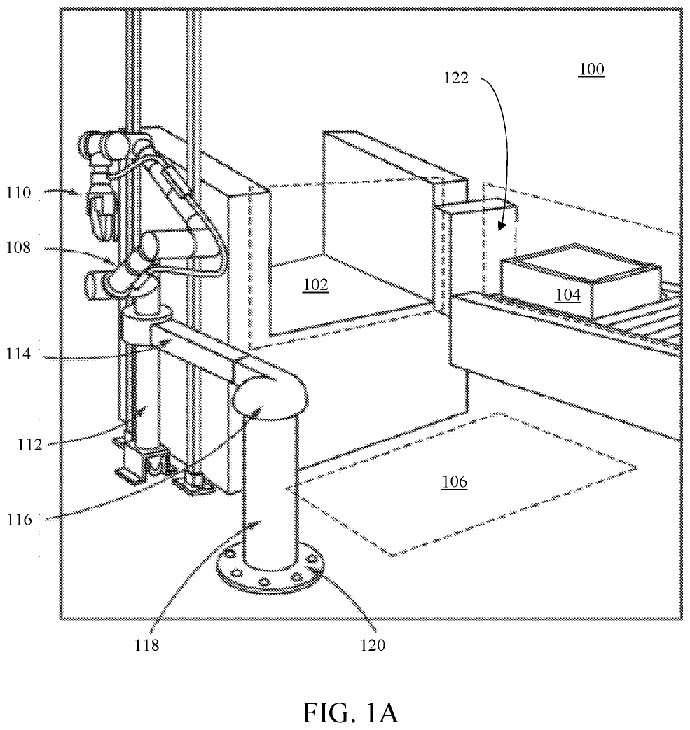

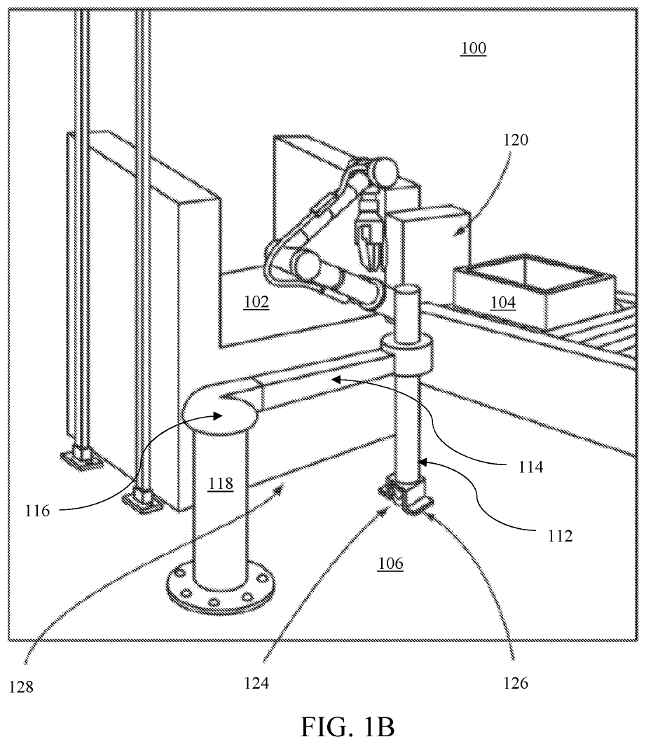

FIG. 1A illustrates a reconfigurable robotic workstation 100 in accordance with one embodiment. The workstation 100 of FIG. 1A may include a pick location 102 and a placement location 104. The workstation 100 also includes a work space 106 in which a human operator and a robotic device may perform some task or operation (at different times). For example, the operation may involve picking an item from the pick location 102 and placing the item in the placement location 104. The placement location 104 may be a box on conveyor belt and, once filled with the desired item(s), be moved to some other location for further processing, shipment, etc.

FIG. 1A also illustrates a robotic device comprising a robot arm 108 and an end effector 110 in the form of a gripper. The robot arm 108 may include one or more linked portions that are actuated by a series of motors and/or actuators such as hydraulic or pneumatic actuators.

The robot arm 108 may be operably connected to a movable vertical support member 112, and also a horizontal support member 114 which is further connected to a rotational coupling 116. The rotational coupling 116 may be mounted on a permanent vertical support 118 that is secured to a permanent floor mount 120. Although not shown in FIG. 1A, any one or more of the movable vertical support member 112, the horizontal support member 114, the rotational coupling 116, and the permanent vertical support 118 may be configured with sensors and any required computer vision processing tools.

FIG. 1A shows the workstation 100 in a human operator state. That is, the work space 106 is generally empty such that a human operator may perform a task therein. The robot arm 108 and related components are in a stowaway configuration outside of the work space 106 so as to not interfere with the human operator.

The workstation 100 may include a combination of moving or rotating mechanical parts and supports to move the robotic device between the stowaway configuration (as in FIG. 1A) and the work space 106. Although not shown in FIG. 1A, the workstation 100 may also include one or more sensor devices to verify that the robotic device is properly positioned in the work space 106 before the robotic device begins performing a task.

For example, housing 122 may store any required computing equipment, power supplies, peripheral devices, or the like. While processing equipment may be located in or otherwise at the workstation 100, processing equipment may additionally or alternatively be located at a remote location.

FIG. 1B illustrates the workstation 100 in accordance with another embodiment. As seen in FIG. 1B, the robotic device has been moved into the work space 106 such that it can pick items from the pick location 102 and place items in the placement location 104.

The robotic device may be moved into the work space by rotating the horizontal support member 114 clockwise or counter-clockwise about the permanent vertical support 118 via the rotational coupling 116. For example, the rotational coupling 116 and/or the permanent vertical support 118 may be configured with a series of motors, gears, actuators, or the like to autonomously move the robotic device into the work space 106. Additionally or alternatively, a human operator may manually move the robotic device into the work space 106 by rotating the robotic device about the permanent vertical support 118.

The movable vertical support member 112 may be operably configured to include a wheel 124 to facilitate the movement between the first, stowaway state shown in FIG. 1A and the second state in which the robotic device is in the work space 106 as shown in FIG. 1B. The wheel may be operably connected to a spring or other dampening mechanism to compensate for uneven surfaces or irregularities in the floor.

As discussed previously, it may be important for the robotic device to be properly positioned and secured in the work space 106 before the robotic device begins performing its assigned task. Failure to properly position or secure the robotic device may result in collisions between the robotic device or the support components with other objects in the work space or people. Failure to properly position or secure the robotic device may also result in degraded performance.

Accordingly, the workstation 100 or the components in the workstation 100 may include one or more mechanical devices and/or one or more verification sensors to verify the position of the robotic device in the work space 106. For example, the work space 106 may include a removable floor coupling 126 to removably secure the movable vertical support member 112 in the work space 106.

In some embodiments, the removable floor coupling 126 may include a pair of threaded screws to secure the movable vertical supper member 112 into threaded inserts that have been set into the floor of the work space 106. This allows a permanent floor mount in the work space 106 (not shown in FIGS. 1A & B) to be fully recessed so as to not create a tripping hazard.

Any other type of coupling mechanisms may be used to removably secure the movable vertical support member 112 (and therefore the robotic device) in the work space 106. These mechanisms may include, for example and without limitation, a series of magnets, bolts, screws, hook-and-loop fasteners, clamps, locks, or the like. The exact configuration of the coupling mechanisms may vary as long as the robotic device can be removably secured in the work space 106 to perform the required task.

The location of the coupling mechanism(s) used vary as well. In addition to or in lieu of the floor, the coupling mechanism(s) may be positioned in the ceiling of the workstation 100, the wall(s) of the workstation 100, support beams in the workstation 100, or configured with other equipment in the workstation 100 so that the robotic device can be removably secured in a desired position.

As alluded to above, the workstation 100 or components thereof may also include one or more verification sensors to verify the position of the robotic device. The workstation 100 may also include one or more verification sensors to verify the position of any required imaging cameras or sensors relative to each other as well as to the pick location 102 and/or placement location 104.

For example, these sensors may include limit/contact switches, optical encoders, magnetic sensors, capacitive sensing devices, electrostatic sensing devices, or the like. This list of sensor devices is merely exemplary and other types of sensor devices whether available now or invented hereafter may be used to accomplish the features of the embodiments described herein. These verification sensors may be embedded in or otherwise configured as part of the removable coupling 126, for example.

In some embodiments, fiducials may be placed on certain components in the workstation 100 (e.g., the pick location 102, the placement location 104, mounts, camera frames, etc.). These fiducials would therefore allow the robotic device or other components of the workstation 100 to “self-verify” that the relative positioning of the components is correct before beginning operation.

The robotic device may be subject to certain controls or policies such that, until the verification sensors verify that the robotic device is properly positioned in the work space 106, the robotic device is unable to perform an operation. Once the position of the robotic device is verified, the robotic device may be permitted to perform the required operation(s). FIG. 1B also shows a compartment 128 that may store any required wiring, cabling, or processing equipment to verify the robotic device is properly positioned.

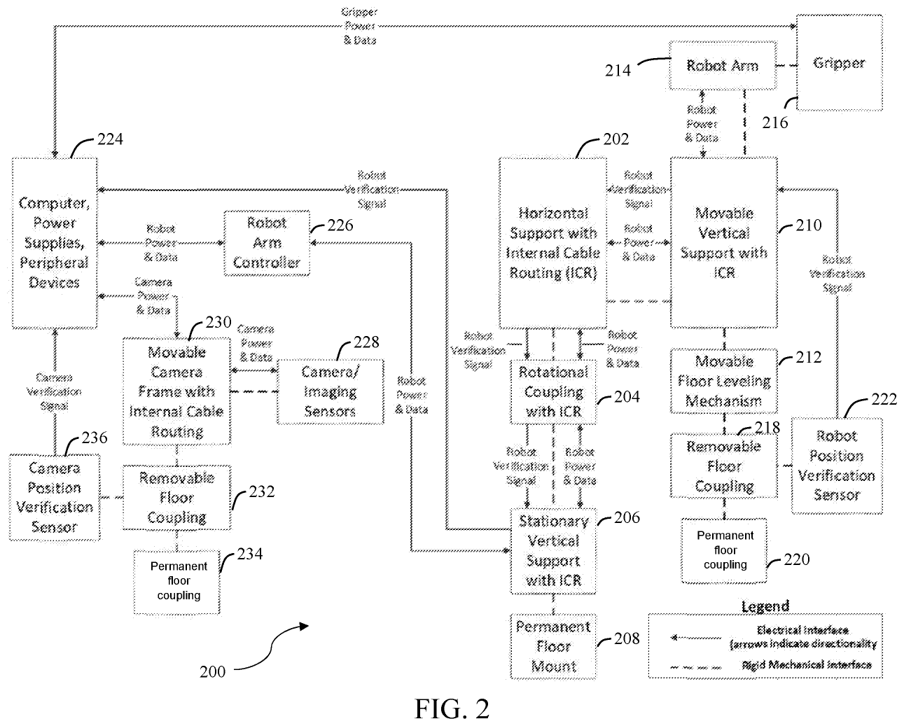

FIG. 2 illustrates the architecture 200 of a reconfigurable robotic system in accordance with one embodiment. Several of the components shown in FIG. 2 are also shown in FIGS. 1A & B. The architecture 200 of FIG. 2 will be described in accordance with the process of reconfiguring a workstation such as the workstation 100 of FIGS. 1A & B from a stowaway state in which the robotic device is outside of a work space into an operational state in which the robotic device is in the work space to perform some task.

To transition between these operational states, a human operator may move the horizontal support 202 about the rotational coupling 204. The horizontal support 202 and the rotational coupling 204 may be similar to the horizontal support member 114 and the rotational coupling 116, respectively, of FIGS. 1A & B. As seen in FIG. 2, each of the horizontal support 202 and rotational coupling 204 may include any required internal cable routing (ICR) to communicate signals while reducing tripping hazards.

Additionally or alternatively, the rotational coupling 204 may include or otherwise be configured with a powered assist feature such as a motor or the like. This motor or other type of feature could make moving the various components of the workstation easier for a human operator, or may even move the various components of the workstation without requiring human operator involvement.

Regardless of whether a human operator is involved in the transition, the horizontal support 202 may be rotated about the stationary vertical support 206, which is connected to a permanent floor mount 208 in or in proximity to the work space. The stationary vertical support 206 and the permanent floor mount 208 may be similar to the permanent vertical support 118 and permanent floor mount 120, respectively, of FIGS. 1A & B.

The movable vertical support 210 may be similar to movable vertical support member 112 of FIGS. 1A & B. The movable vertical support 210 may also move about the rotational coupling 204 as the horizontal support 202 moves about the rotational coupling 204. The movable vertical support 210 may include a moveable floor leveling mechanism 212 such as a spring-loaded wheel to facilitate movement of the movable vertical support 210 across uneven surfaces.

As shown in FIG. 2, the movable vertical support 210 supports or is otherwise operably connected to a robot arm 214 with a gripper 216. The robot arm 214 and the gripper 216 may be collectively referred to as the robotic device.

Once the movable vertical support 210 is in the work space, it may be removably secured to the removable floor coupling 218. The removable floor coupling 218 may include any one or more of magnets, bolts, screws, hook-and-loop fasteners, clamps, locks, or the like. The removable floor coupling 218 may be configured as part of the movable floor leveling mechanism 212 or the movable vertical support 210, and may be configured to removably connect to a permanent floor coupling 220.

The exact configuration of the permanent floor coupling 220 may vary and may depend on the type and structure of the removable floor coupling 218. For example, the permanent floor coupling 220 may include one or more threaded holes for receiving threaded screws.

The couplings are not limited to floor couplings, either. Rather, couplings may be integrated in other locations in the work space, such as in a wall, ceiling, support beams, other equipment, or the like.

Once the robotic device is properly positioned in the work space (e.g., once the removable floor coupling 218 is removably secured to the permanent floor coupling 220), a robot position verification sensor 222 may communicate a signal to the robot arm 214 or other type of computer, processing equipment, power supplies, peripheral devices, etc. (hereinafter “processor 224”). The processor 224 may then issue one or more commands to a robot arm controller 226 such that the robot arm 214 can perform the required task(s).

As discussed previously, the workstation in accordance with various embodiments may include one or more cameras or imaging sensors 228 (for simplicity, “imaging sensors 228”) to gather data regarding the work space. For example, this data may include the location and orientation of items to be picked by the gripper 216. Similarly, this data may indicate where the placement location is so that the robotic device knows where to place the picked items.

The imaging sensors 228 may include any one or more of RGB cameras, stereoscopic cameras, LIDAR, sonar sensors, etc. The exact type or configuration of the imaging sensors 228 used may vary and may include any type of sensor device whether available now or invented hereafter as long as they can gather imagery so that the robotic device can perform the required tasks.

The imaging sensors 228 may be operably connected to or configured with a movable camera frame 230 to adjust the position and orientation of the imaging sensors 228. The camera frame 230 may be configured as part of the hardware components of the workstation such as those discussed previously. As with several other hardware components, the camera frame may include internal cable routing to hide any required wires or cables to at least minimize tripping hazards.

The camera frame 230 may also be connected to a removable floor coupling 232, which can be removably secured to a permanent floor coupling 234 to secure the frame 230 in an appropriate position. If the camera frame 230 is configured with other hardware components of the workstation such as those discussed previously, the removable floor coupling 232 and the permanent floor coupling 234 may be the same as the removable floor coupling 218 and the permanent floor coupling 220.

As seen in FIG. 2, the architecture 200 may also include one or more camera verification sensors 236 to verify that any required imaging sensors 228 are properly positioned. The camera position verification sensor 236 may rely on, for example, the removable floor coupling 232 to be secured to the permanent floor coupling 234 to ensure proper positioning. Additionally or alternatively, the camera position verification sensor 236 may rely on one or more fiducials at various locations in the work space to ensure the imaging sensors 228 are properly positioned.

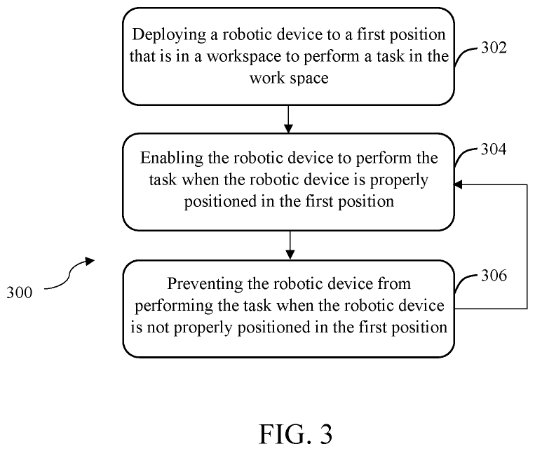

FIG. 3 depicts a flowchart of a method 300 for operating a reconfigurable robotic system in accordance with one embodiment. The reconfigurable robotic system may operate in a work space similar to the work space 106 of FIGS. 1A & B.

Step 302 involves deploying a robotic device to a first position that is in a work space to perform a task in the work space. The robotic device may include a robot arm and gripper such as the robot arm 108 and gripper 110 of FIGS. 1A & B. The first position may refer to a position in a work space such in a warehouse environment in which the robotic device is tasked with performing a pick-and-place operation.

Step 304 involves enabling the robotic device to perform the task when the robotic device is properly positioned in the first position in the work space. The robotic device or components in the work space may include or otherwise be in operable communication with one or more sensor devices to verify that the robotic device (e.g., by virtue of is connections with other hardware components) is properly positioned in the work space. This may be verified by one or more verification sensors such as those described previously.

Step 306 involves preventing the robotic device from performing the task when the robotic device is not properly positioned in the first position in the work space. As discussed previously, the robotic device may collide with other objects or people in the work space or may be unable to successfully perform the required operation(s).

Accordingly, the work space may execute certain security or control policies such that, failure of the verification sensor(s) to communicate a signal that the robotic device is properly positioned, the robotic device will be prevented from performing the task. For example, power may be cut off to the robotic device unless the verification sensor detects that the robotic device is properly positioned.

Steps 304 and 306 may be constantly iterated or otherwise repeated. In other words, the robotic device may perform the task as long as the robotic device is properly positioned in the first position. Once it is detected that the robotic device is not properly positioned in the first position, the robotic device may be prevented from performing the task.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A reconfigurable robotic system, the reconfigurable robotic system comprising:
a robotic device configured to be deployed to a first position that is in a work space to perform a task in the work space, and further configured to be moved to a second position that is outside of the work space while not performing the task; and
at least one verification sensor to verify that the robotic device is properly positioned in the first position before the robotic device performs the task in the work space.

2. The robotic system of claim 1 wherein the robotic device is operably connected to a support member configured to move the robotic device between the first and second positions.

3. The robotic system of claim 2 wherein the support member is a vertical support member mounted to a floor portion at a location such that the vertical support member can facilitate moving the robotic device between the first and second positions.

4. The robotic system of claim 3 further comprising a horizontal support member connecting the robotic device to the vertical support member, wherein the horizontal support member pivots about the vertical support member to facilitate moving the robotic device between the first and second positions.

5. The robotic system of claim 1 wherein the robotic device is configured to be removably attached to a coupling to fix the robotic device in the first position.

6. The robotic system of claim 5 wherein the coupling is removably attached to a location in the work space or in proximity to the work space.

7. The robotic system of claim 1 wherein the robotic device is configured to self-verify that it is properly positioned in the first position by detecting one or more fiducial markers in the work space or in proximity to the work space.

8. The robotic system of claim 1 wherein the robotic device is configured to perform a pick-and-place task in the work space while in the first position.

9. The robotic system of claim 1 further comprising a compensation mechanism to allow for variations in floor height between at least the first and second positions.

10. A method for operating a reconfigurable robotic system, the method comprising:
deploying a robotic device to a first position that is in a work space to perform a task in the work space;
enabling the robotic device to perform the task when the robotic device is properly positioned in the first position in the work space; and
preventing the robotic device from performing the task when the robotic device is not properly positioned in the first position in the work space.

11. The method of claim 10 further comprising moving the robotic device about a support member from the first position to a second position.

12. The method of claim 11 wherein the support member is a vertical support member mounted to a floor portion at a location such that the vertical support member can facilitate moving the robotic device between the first and second positions.

13. The method of claim 12 wherein the robotic device is operably connected to a horizontal support member, and the horizontal support member is configured to pivot about the vertical support member.

14. The method of claim 10 further comprising removably attaching the robotic device to a coupling to fix the robotic device in the first position.

15. The method of claim 14 wherein the coupling is removably attached to a location in the work space or in proximity to the work space.

16. The method of claim 10 wherein properly positioning the robotic device in the first position comprises detecting, by the robotic device, one or more fiducial markers in the work space or in proximity to the work space.

17. The method of claim 10 further comprising receiving confirmation that the robotic device is properly positioned in the first position in the work space before enabling the robotic device to perform the task.

18. The method of claim 10 further comprising configuring the reconfigurable robotic system with a compensation mechanism to allow for variations in floor height when moving the robotic device to the second position.

19. A reconfigurable robotic system, the reconfigurable robotic system comprising:
a robotic device configured to perform a task in a work space;
a support member facilitating movement of the robotic device between a first position in which the robotic device can perform the task in the work space and a second position that is outside of the work space; and
an attachment point configured to removably receive the robotic device to properly position the robotic device in the first position.

20. The robotic system of claim 19 further comprising at least one verification sensor to verify that the robotic device is properly positioned in the first position before the robotic device performs the task in the work space, wherein the at least one verification sensor is configured with the attachment point.
